(19) United States
(12) Patent Application Publication
(10) Pub. No.: US 2002/0040482 A1
(43) Pub. Date: Apr. 4, 2002

(54) Features for interactive television

(76) Inventors: Gary L. Sextro, Frisco, TX (US); John R. Reder, Richardson, TX (US); Roger S. Carver, Richardson, TX (US); Timothy L. Ryan, McKinney, TX (US); James F. Headley, McKinney, TX (US); Anna Antoszkiewicz, Little Elm, TX (US)

Correspondence Address: TEXAS INSTRUMENTS INCORPORATED, P O BOX 655474, M/S 3999, DALLAS, TX, 75265

(21) Appl. No.: 09/829,468

(22) Filed: Apr. 9, 2001

Related U.S. Application Data
(60) Provisional application No. 60/195,411, filed on Apr. 8, 2000.

(51) Int. Cl. H04N 7/16

(52) U.S. Cl. 725/136

(57) ABSTRACT

An interactive television that combines the video/audio content, delivered by existing broadcast methods, with the interactive Internet capabilities, delivered by existing network methods. In this approach, mixed media, including fall frame-rate high definition video, audio, text, and graphics are delivered via mixed transmission mediums, both traditional broadcast and the Internet. This provides for personalized content, both video and Internet, and allows interactive content to be developed by third parties.

### FIELD OF THE INVENTION

The present invention relates to television and more particularly to active medium television combining both broadcast and Internet protocol.

### BACKGROUND OF THE INVENTION

Television traditionally has been a passive medium in which all viewers receive and display the same sequence of images. Viewers desire a more interactive experience, however, in which they have some control over the content of the displayed images.

For example, in today's world it would be desirable to receive video over traditional terrestrial or cable broadcast and overlay Internet content in the form of stock quotes, e-mail messages, sporting event scores, available food delivery, etc. on the video.

In the past, there have been many ideas for the implementation of such interactive television. The majority of these approaches eliminate traditional broadcasts and utilize the Internet as the primary delivery channel. Current Internet delivery mechanisms, including broadband, however, are not capable of delivering high definition video at full frame rates. Since current broadcast architectures tend to only offer one-way delivery, there is a need for two-way communication that offers the desired interactivity. The present invention meets this need by combining the high definition video capabilities of one-way broadcast with the interactive capabilities of two-way Internet.

### SUMMARY OF THE INVENTION

This invention discloses an interactive television method and system that does not try to force existing media, video or Internet content, through a single transmission medium, either broadcast or packet based network. Rather, this solution combines the video/audio content, delivered by existing broadcast methods, with the interactive Internet capabilities, delivered by existing network methods.

The Internet content is either displayed along the edges of the screen, intruding only slightly on the broadcast video, or is alpa blended with the video so as to not completely obscure the video image. This approach provides for personalized video and Internet content, and allows interactive content to be developed by third parties using simple Web tools like HTML and Javascript.

In this solution, mixed media, including full frame-rate high definition video, audio, text and graphics is delivered via mixed transmission mediums such as a combination of broadcast and the Internet transmissions. This combines the highest performance aspects of the broadcast world and the Internet world, presenting all media with high resolution content.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram showing the system architecture for the delivery system in the interactive television of the presented invention.

FIG. 2 illustrates the use, in the present invention, of either an advanced high-definition interactive television set or a standard television set retrofitted with an interactive set-top box.

FIG. 3 is a diagram showing one delivery system that can be used in the present invention where broadcast video/audio is received and Internet content is both received and sent via satellite.

FIG. 4 is a layout for one embodiment of the interactive television display screen of the present invention, which includes t-commerce buttons, a streaming data window, and a Family Quickview window, where each family member has a personalized content file that can be opened using tabs along the right side of the display screen, all overlaid over the live video.

FIG. 5 is an example of the interactive television showing live video with superimposed interactive content for the real-time purchase of tickets to ride a train.

FIG. 6 is an example where the interactive system is used to deliver pushed advertisement, with embedded video, to the viewer.

FIG. 7 is an example of a travel application purchase being made in real-time for the pushed Hula Bowl advertisement of FIG. 6 using the interactive television of the present invention.

FIG. 8 is an example of the interactive television travel application offering various vacation packages.

FIG. 9 is an example of the interactive television where one of the travel offerings in FIG. 8 is selected and expanded using high-resolution graphics, along with embedded video.

FIG. 10 is an example of the interactive television of the present invention showing a sporting event with superimposed streaming data across the bottom of the display screen presenting the scores of other games of interest. The streaming data can be interactively edited using the included Edit window.

FIG. 11 is an example of the interactive television of the present invention showing high-resolution live video of a market discussion with superimposed streaming data content of a personalized portfolio across the bottom of the display screen. The portfolio entries can be edited using the Edit My Portfolio window provided.

### DETAILED DESCRIPTION OF THE PREFERRED EMBODIMENTS

The present invention discloses an interactive television method and system that does not force existing media, including video and Internet content, through a single transmission medium-either a broadcast transmission or packet based network. Rather, this solution combines the video/audio content delivered by existing broadcast methods with the interactive Internet capabilities delivered by existing network methods.

FIG. 1 is a block diagram showing the system architecture for the delivery system in the interactive television of the present invention. This shows the one-way (incoming) high-resolution broadcast video/audio 100 as an input to the television tuner 102 and the two-way (receive-send) Internet content 101 as an input to a standard Internet browser 103. The data outputs 104/105 from the television tuner 102 and the Internet browser 103 are fed into a graphics processor 106 where the two are superimposed and coupled 107 into display 108. Interactive content is fed back from the display 108 by means of the interactive connection 109, through the Internet browser 103 and via the two-way Internet content path 101 to the Internet service provider.

As shown in FIG. 2, the interactive features of the present invention can be used with either an advanced television 200 or with a standard television 211 that has been retrofitted with an interactive set-top box 210. In either case, the broadcast video/audio 205 provides only one-way communication, while the Internet content connection 206 allows for two-way communication where data is both received and sent by a viewer.

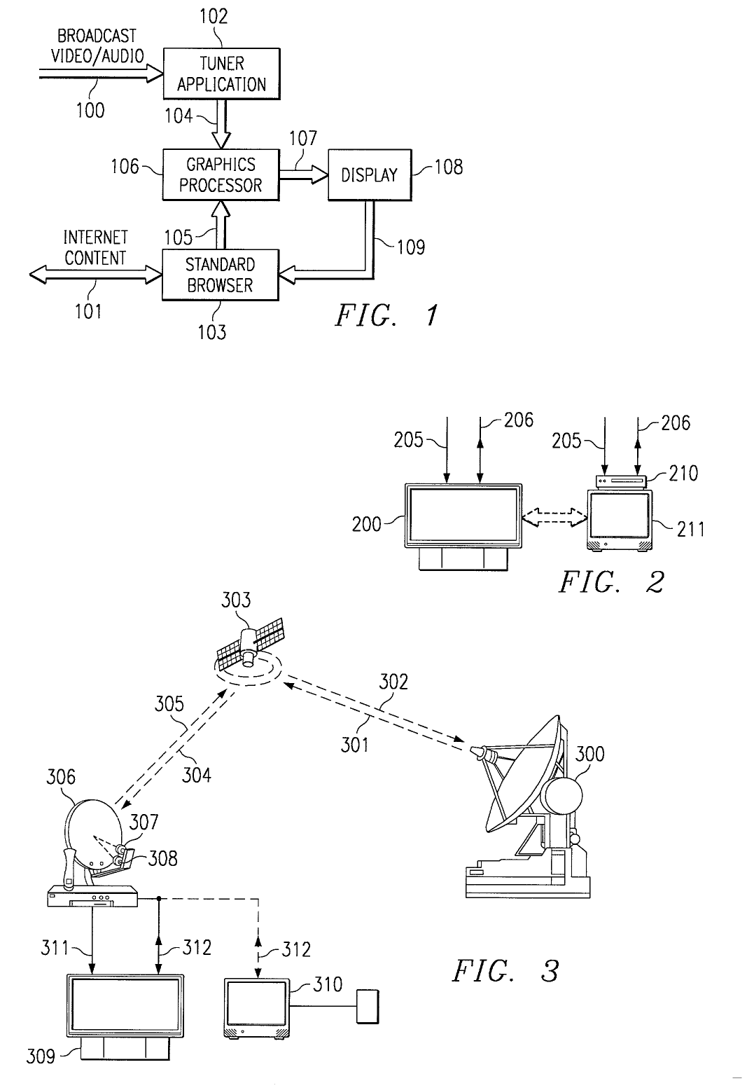

With today's technology, there are many ways to deliver the interactive, mixed media capability of the present invention, including radio frequency broadcast, cable, satellite, and landline (telephone). A number of delivery method combinations are listed in Table 1 below. One example of the interactive, mixed media delivery of the present invention is shown in FIG. 3 where downlink broadcast video/audio content is received and both downlink and uplink Internet content is received and sent via satellite 303. In this case the media provider sends 301 broadcast video and both sends 301 and receives 302 Internet content to/from a satellite 303. In turn, the satellite 303 sends 304 broadcast video/audio and sends 304 and receives 305 Internet content to/from a satellite dish 306 at the viewer's residence or business. This dish 306 has dual low noise block converters (LNBs) 307/308, one for the broadcast video 307 and one for Internet content 308. The one-way broadcast video 311 and the two-way Internet data 312 are then coupled from the respective LNBs 307/308 to an interactive television 309. Optionally, the Internet connection 312 can be made to a computer 310 in the home for completely independent operation from the interactive television.

Table 1

TABLE 1

| Broadcast Video Received | | |
|---|---|---|
| via | Internet Data Received via | Internet Data Sent via |
| Satellite | Satellite | Satellite |
| Satellite | Satellite | Landline |
| Satellite | Cable | Cable |
| Satellite | Landline | Landline |
| Cable | Cable | Cable |
| Cable | Landline | Landline |
| Cable | Satellite | Satellite |
| Cable | Satellite | Landline |
| Antenna | Satellite | Satellite |
| Antenna | Satellite | Landline |
| Antenna | Cable | Cable |
| Antenna | Landline | Landline |

In the present invention, mixed video, including full frame-rate high-definition video, audio, text, and graphics, is delivered via mixed transmission mediums; such as both traditional broadcast and the Internet. This takes advantage of the best features of both broadcast transmission and the Internet networks, with all media being presented at high-resolution; e.g., 1280×720 or greater resolution. This approach allows the Internet content to occupy significantly less screen space, thereby being less intrusive on the video. It also allows the video content to include standard definition, DVD, or high-definition with excellent video reproduction. As a result, a whole new world of interactive television is introduced, as discussed below.

Taskbars are used to display information for various view accounts in the home or business. For example, e-mail summaries and reminders for upcoming broadcast events. A software agent can place various e-commerce sites in a window or taskbar based on the broadcast being viewed. For example, if an evening movie is being displayed, the agent based on viewer preferences and past viewing habits, may place local pizza delivery advertising and ordering content in the window or taskbar.

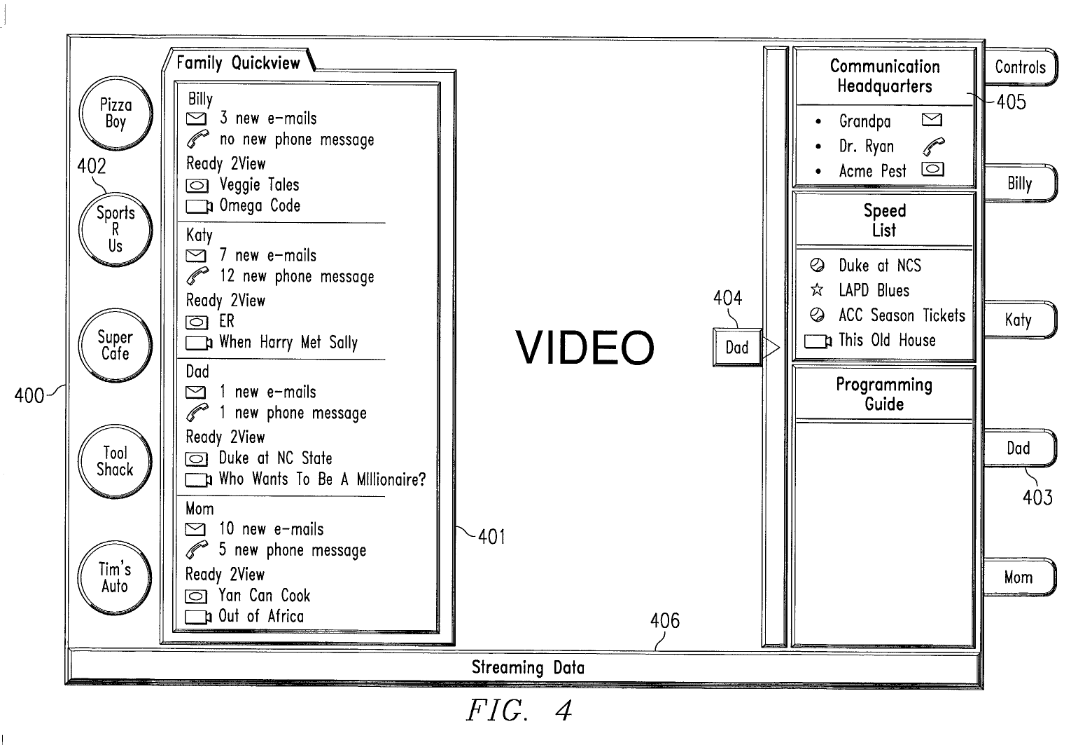

FIG. 4 shows one embodiment for the layout of the interactive television display screen 400 of the present invention. This example is for a 16:9 aspect ratio advanced interactive display with live video and superimposed pop-up interactive windows 401-406. The windows are addressed by the means of the particular television, such as a cursor and remote control unit. As shown, a Family Quickview window 401 can be brought up to quickly identify personalized content for each family member.

In the example shown, dad has one new e-mail, one phone message, and programs waiting for his attention. Dad can click on his control tab 403 on the right edge of the screen to bring up his Communications Headquarters file 405 along the right-hand portion of the screen. Another center tab 404 identifies whose files are in the Communications Headquarters window 405. Here he can see whom the calls and e-mails are from and what programs are ready for his viewing. In this case, dad also has an offer to purchase ACC season tickets. He can also bring up the programming guide from this window. Along the left side of the screen television-commerce (t-commerce) buttons 402 are included, which can be identified and implemented through impulse buying, links to traditional e-commerce sites, or sponsorships for particular programs. For example, button 402 addresses the Sports R Us e-commerce site where real-time orders can be placed. Streaming data is displayed in a window 406 along the bottom of the display screen. The streaming data can be used, for example, to display updated portfolio stock data or the latest scores for various sporting events. The interactive system of the present invention is designed to alpha blend the Internet content data so as to minimize obscuring of the underlying video.

Alternatively, the system can be used solely as a broadcast video or an Internet display, if so desired.

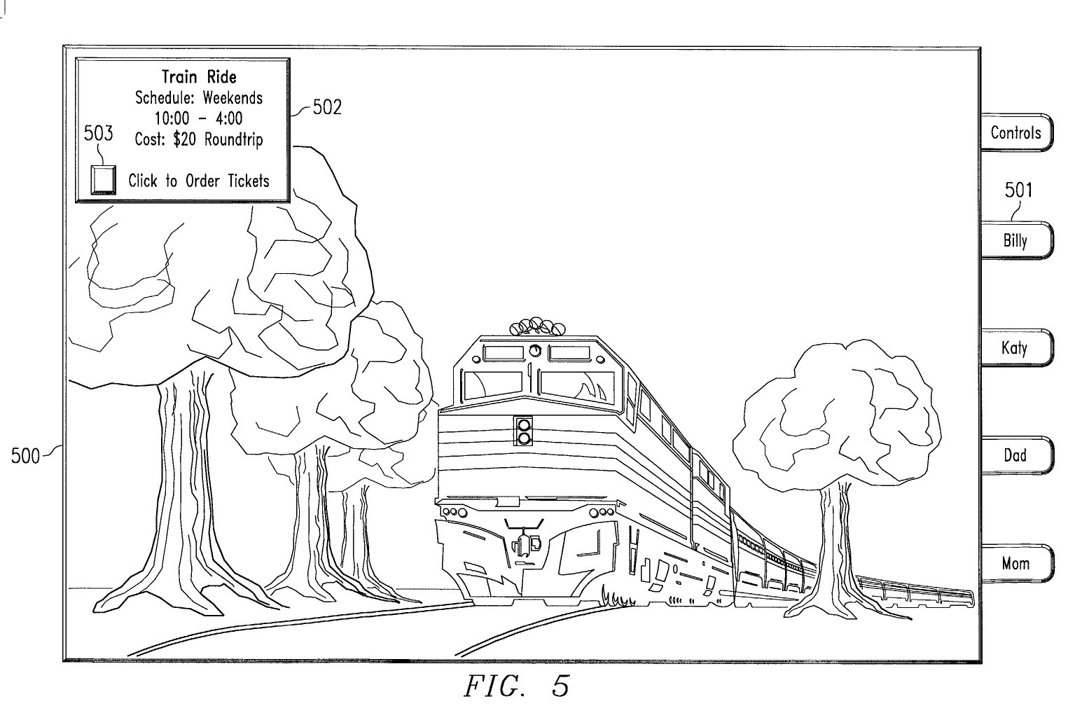

FIG. 5 is a simulation example showing live video 500 with a superimposed window 502 containing interactive content 503 for the real-time purchase of tickets to ride a train. In this case, live video from the train ride is presented along with content on the train schedule, cost, highlights, etc. An interactive box can be addressed by the available means of the television to purchase a ticket in real-time. Also, shown along the right side of the screen are the tabs 501 for the family members to quickly access their individual data files.

Large revenues can be generated through pushed advertisements via the interactive television. Commands embedded in the video stream could prompt access to Internet sites offering related products and services. For example, viewers of college football games could be offered travel packages to upcoming games or post-season games for the teams playing. These products and services can be optimized by viewer-selected preferences, analysis of viewing habits, or by accessing databases of personal information, such as alumnus lists from a particular school.

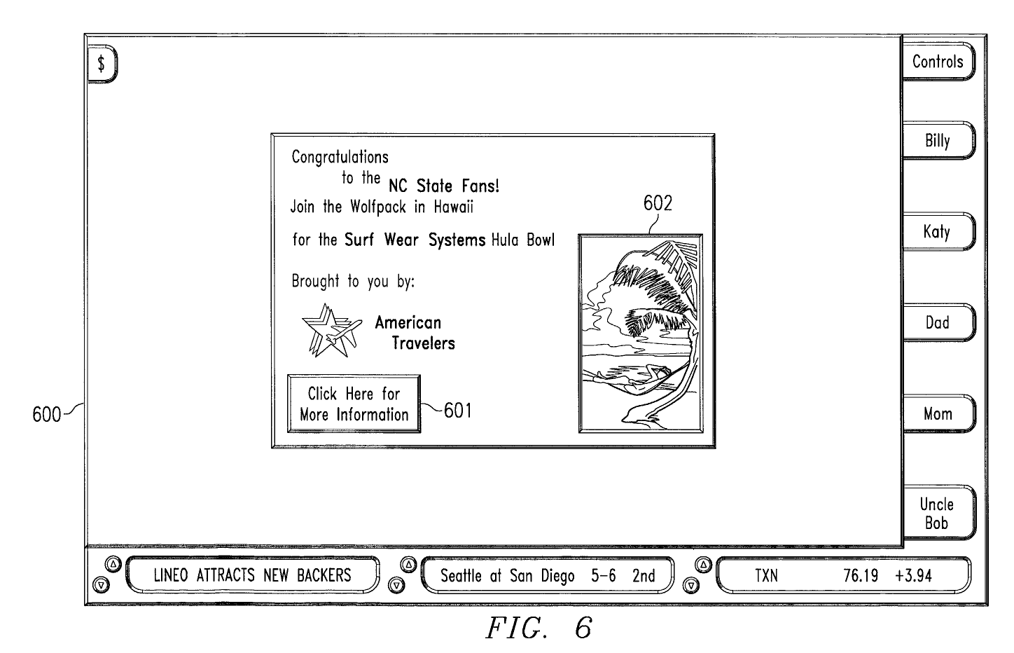

FIG. 6 is an example of the interactive system being used to deliver pushed advertisement with embedded video to selected viewers of a particular school. The screen 600 can have live video or the system may be addressed for viewing Internet data only (as shown). In this case the pushed advertisement is a special travel package 601 with embedded video 602 targeted at North Carolina State fans wishing to join the team at the Hula Bowl.

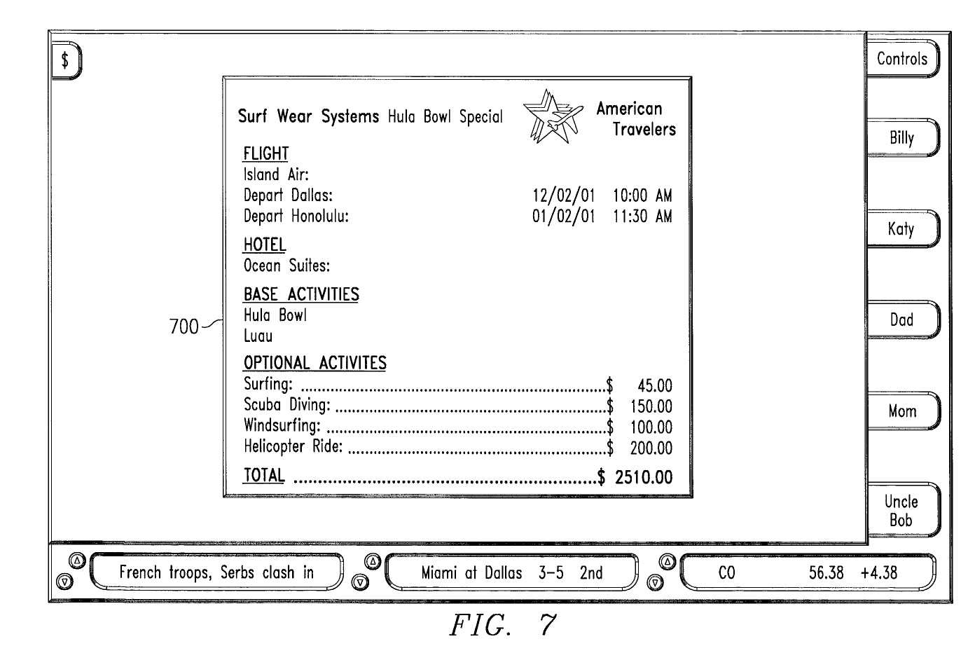

If the viewer is interested in supporting the team at the Hula Bowl, the pushed Ad is clicked to bring up an interactive scheduling screen 700 as shown in FIG. 7. Here the viewer can obtain all the details relating to the schedule, cost, etc. and make real-time reservations.

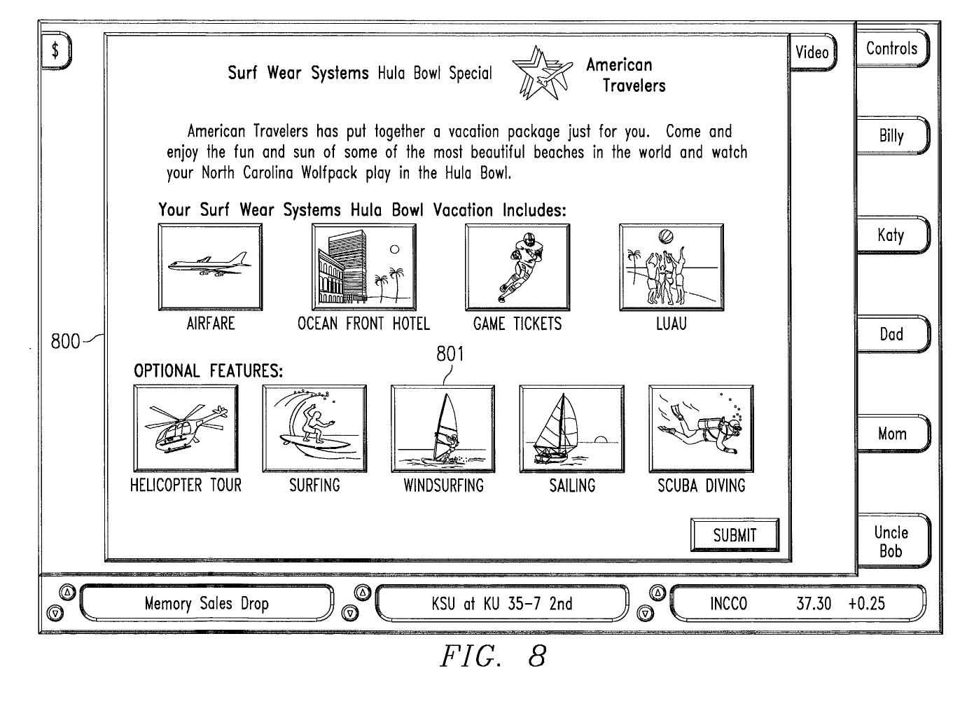

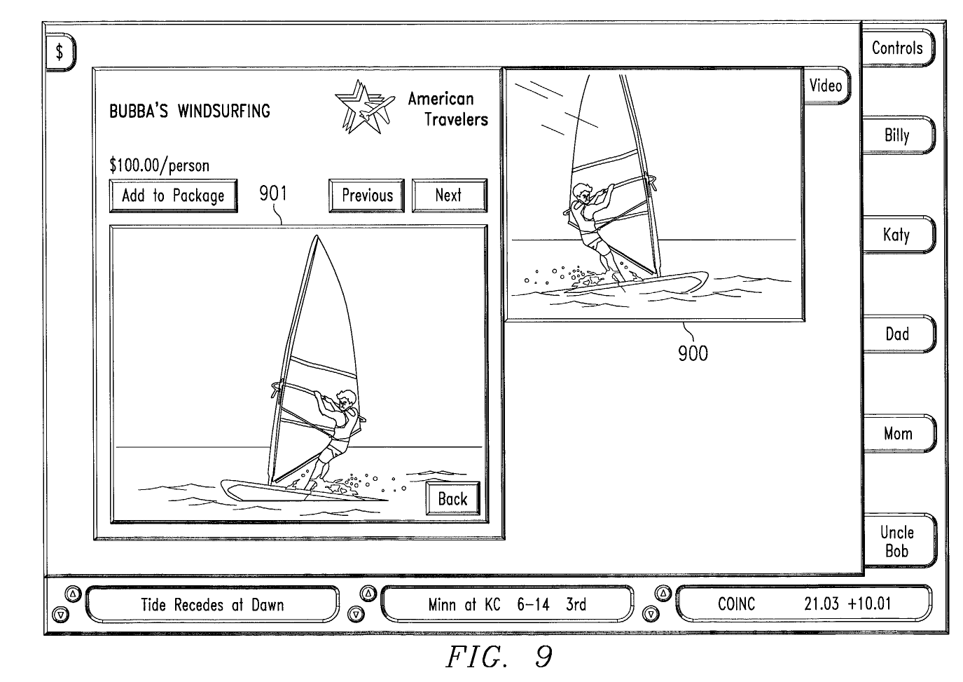

FIG. 8 is an example where a group of vacation packages 800 are being offered on the interactive television of the present invention. In this case, the viewer is interested in package 801 and, by selecting it, opens up a larger screen 901 with additional links to more information as shown in FIG. 9. An insert 900 is included showing high-resolution video clips relative to the application.

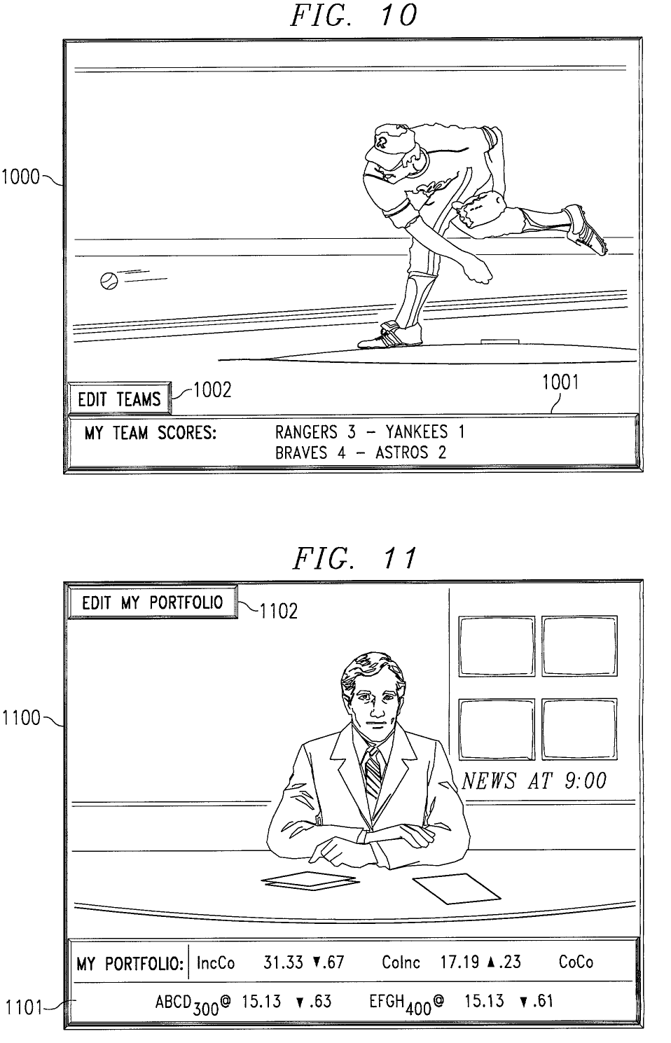

Interactive television can have a huge impact in the area of sporting events. FIG. 10 is an example where the viewer is watching video 1000 of a baseball game with streaming data 1001 providing live updates of other selected games and statistics. The viewer can edit the teams and/or information to be updated using the Edit window 1002.

The approach of the present invention provides a smooth transition for traditional broadcast with embedded HTML or Java-like commands to access the interactive features of advanced televisions. These embedded commands enable synchronization and correlation to additional internet-based content that is displayed with the broadcast signals.

The embedded commands can also be used as delimiters, setting one set of data apart from another, to allow television that stores video sequences access to video clips. For example, the broadcast of a football game might place headers between plays, allowing advanced viewers to select one or more plays in a drive to be stored and replayed at the end of a drive. The drive summary may consist of a written description or a graphic. An ideal graphic might include arrows showing the progression of the drive down the football field, with various colors and shapes arrows and shapes used to denote the type of plays or penalties that moved the line of scrimmage. Interactivity could also be used to allow viewers to vote whether they agreed with a referee's call, or what type of play they would call. For the case of standard non-interactive television, a fixed sub-set of data could be provided to all non-interactive viewers.

The interactive television of the present invention can also utilize streaming data to provide an interactive experience for the investor, as shown in FIG. 11. Here the investor selects a portfolio of stocks of interest using the Edit My Portfolio window 1102. While watching broadcast video 1100, the television extracts the ticker data for those stocks from all the market data embedded in the video stream, and displays it in a banner 1101 across the bottom of the screen.

While the present invention has been described in the context of a preferred embodiment, it will be apparent to those skilled in the art that the present invention may be modified in numerous ways and may assume embodiments other than that specifically set out and described above. Accordingly, it is intended by the appended claims to cover all modifications of the invention that fall within the true spirit and scope of the invention.

What is claimed is:

1. A method for interactive television, the method comprising:
providing a traditional broadcast signal comprising a video stream;
embedding commands in the video stream, said embedded commands operable to access interactive features, said embedded commands synchronized and correlated with additional Internet-based content; and
displaying said additional Internet-based content superimposed on said video stream from said traditional broadcast signal.

2. The method of claim 1, said embedding comprising embedding HTML or Java-like commands.

3. The method of claim 1, comprising:
providing a digital interactive set-top box coupled to a standard television, said interactive set-top box accessing said additional Internet-based content and superimposing said content on said video stream.

4. The method of claim 1, said embedding comprising embedding delimiters to define sequential video clips for storage and future display.

5. The method of claim 1, said embedding comprising embedding delimiters to define sequential video clips for storage and future display, each of said sequential video clips comprising a segment of a sporting event.

6. The method of claim 5, comprising:
storing one or more of said video clips of said selected plays;
summarizing said stored video clips with a graphic summary including coded indicators denoting types of plays; replaying one of said video clips upon viewer selection of a corresponding said coded indicator.

7. The method of claim 6, comprising selecting a fixed graphic format for viewing on a standard non-interactive television.

8. The method of claim 1, said embedding comprising embedding commands in said video stream to facilitate polling of viewers, allowing said viewers to vote on an aspect of said simultaneously displayed broadcast data.

9. The method of claim 1, said embedding comprising embedding commands in said video stream to prompt access to Internet sites offering pushed products.

10. The method of claim 1, said embedding comprising embedding commands in said video stream to prompt access to Internet sites offering pushed products selected from the group consisting of: tickets to future sporting events, travel packages, and sports apparel.

11. The method of claim 1, said embedding comprising embedding commands in said video stream to prompt access to Internet sites offering pushed products selected using at least one selection criteria selected from the group consisting of a viewer's indicated preferences, analysis of said viewer's habits, and databases of personal information for said viewer.

12. The method of claim 1, said embedding comprising embedding commands enabling a viewer to interactively complete a transaction to purchase various products by selecting an Internet generated icon on the display screen.

13. The method of claim 1, said embedding comprising embedding commands enabling a viewer to interactively complete a transaction to purchase various products and receive confirmation of said transaction in real-time on a display screen.

14. The method of claim 1, said embedding comprising embedding commands utilizing streaming data from said Internet or television broadcast to further enhance the viewing experience by continuously superimposing interactive data in various locations on said broadcast video.

15. The method of claim 1, said embedding comprising embedding commands utilizing streaming data comprising a selected personalized portfolio of stocks, the ticker for said selected portfolio being taken from market data embedded in said video stream and presented and updated in a banner or window on said display screen.

16. The method of claim 1, comprising editing interactive data selected from a group consisting of sports teams and portfolio stocks from a screen menu in real-time.

17. The method of claim 1, comprising providing taskbars displaying various accounts in the home.

18. An interactive television system, comprising:
a broadcast video receiver for receiving video data from a video provider service;
an internet browser providing bidirectional access to internet content;
a graphics processor capable of receiving said broadcast video content and said internet content and providing combined video data comprised of both broadcast video content and internet content; a display in communication with said graphics processor for displaying
said combined video data; and
a viewer interface interpreting viewer input and sending corresponding data content through said internet browser to a third party.

19. The system of claim 18, said internet browser, said graphics processor, and said viewer interface comprising an interactive set-top box.

20. The system of claim 18, wherein:
said broadcast video receiver receives said video data via a transmission channel selected from the group consisting of: satellite transmission, terrestrial broadcast transmission, landline transmission, and cable transmission.

21. The system of claim 18, wherein:
said internet browser receives said internet content via a transmission channel selected from the group consisting of: satellite transmission, terrestrial broadcast transmission, landline transmission, and cable transmission.

22. The system of claim 18, wherein:
said internet browser sends said internet content via a transmission channel selected from the group consisting of: satellite transmission, terrestrial broadcast transmission, landline transmission, and cable transmission.

23. The system of claim 18, wherein:
said broadcast video receiver said video data via a transmission channel selected from the group consisting of: satellite transmission, terrestrial broadcast transmission, landline transmission, and cable transmission.
said internet browser receives said internet content via a transmission channel selecting of: satellite transmission, terrestrial broadcast transmission, line transmission, and cable transmission; and said internet browser sends internet content via a transmission
channel selected from the group consisting of : satellite transmission, terrestrial broadcast transmission, landline tranmission, and cable transmission.
